(19) United States
(12) Patent Application Publication
(10) Pub. No.: US 2013/0302595 A1
(43) Pub. Date: Nov. 14, 2013

(54) SUPER-HYDROPHOBIC AND OLEOPHOBIC TRANSPARENT COATINGS FOR DISPLAYS

(71) Applicants: Biao LIU, San Jose, CA (US); Han-Wen CHEN, San Mateo, CA (US); Steven VERHAVERBEKE, San Francisco, CA (US); Robert VISSER, Menlo Park, CA (US); Kurtis LESCHKIES, Santa Clara, CA (US)

(72) Inventors: Biao LIU, San Jose, CA (US); Han-Wen CHEN, San Mateo, CA (US); Steven VERHAVERBEKE, San Francisco, CA (US); Robert VISSER, Menlo Park, CA (US); Kurtis LESCHKIES, Santa Clara, CA (US)

(21) Appl. No.: 13/797,486

(22) Filed: Mar. 12, 2013

Related U.S. Application Data
(60) Provisional application No. 61/645,336, filed on May 10, 2012.

(51) Int. Cl. C03C 17/00

(52) U.S. Cl. CPC C03C 17/007
USPC 428/336; 428/221; 427/462

(57) ABSTRACT

Embodiments described herein generally relate to methods of creating super-hydrophobic and super-oleophobic layers and the resulting composition of matter. A method for creating a super-hydrophobic and super-oleophobic surface can include positioning a substrate with an exposed surface in a processing chamber, injecting an electrically charged silicon-containing deposition material towards the surface of the substrate, depositing silicon-containing nanofibers onto the exposed surface of the substrate, and depositing a thin low surface energy layer over the exposed surface of the substrate and the silicon-containing nanofibers. A substrate with a super-hydrophobic and super-oleophobic surface can include a substrate with an exposed surface, one or more layers of nanofibers disposed on the exposed surface, and a thin low surface energy material deposited over both the nanofibers and the exposed surface.

### CROSS-REFERENCE TO RELATED APPLICATIONS

This application claims benefit of U.S. Provisional Patent Application Ser. No. 61/645,336 (APPM/17410L), filed May 10, 2012, which is herein incorporated by reference.

### BACKGROUND OF THE INVENTION

1. Field of the Invention

Technology described herein generally relates to methods for forming a super-hydrophobic and super-oleophobic surface.

2. Description of the Related Art

Over the past decade, the market for touchscreen devices, such as smart phones, tablets, and capacitive touch monitors, has grown dramatically. As expected, many of these devices employ touch sensitive glass to allow for interaction without a stylus. Though these devices have largely made portable computing more available and accessible than ever before, the touch sensitive display has a tendency to accumulate oil, dust and debris due to the natural oils left behind from touching the touch sensitive screen.

The problem is further complicated by wiping the screen to clean it. The wipes generally available for cleaning the screen can leave behind scratches in the screen. These scratches can actually increase the future accumulation of oils, dirt and debris. As the device owner cleans the device in the future, scratches will accumulate further magnifying the problem. As the number and type of touchscreen devices that are either on the market or are anticipated in the near future is numerous, the need for cleaning these devices will increase proportionately.

Hydrophobic and oleophobic coatings can be used to increase the contact angle of a surface to liquids and to make the surface smudge and water resistant. However, such surfaces have largely failed to live up to the expectations due to the limitations of flat surfaces.

As such, there is a need in the art for a means of creating a super-hydrophobic and super-oleophobic surface which allows for both transparency and high throughput.

### SUMMARY OF THE INVENTION

One or more embodiments provides solutions to the demand of fingerprint-free surfaces in daily practices like touch screens for touch sensitive devices (such as tablet computers and MP3 players) and displays for laptops, computers, and other appliances. Super-hydrophobic surface formation by Wet Chemical, Electrospinning, Initiated Chemical Vapor Deposition (iCVD), and combinations of the above processes are disclosed herein for smudge-free applications. Embodiments described herein control micro-texturing of the substrate by nanofiber formation with electrospinning and then either form a self-assembled monolayer (SAM) or deposit low-surface-energy, highly hydrophobic polymer coating on the nanofibers.

Embodiments disclosed herein generally relate to methods of creating super-hydrophobic and super-oleophobic layers and the resulting composition of matter. In one embodiment, a method for creating a super-hydrophobic and super-oleophobic layer can include creating a super-hydrophobic and super-oleophobic layer by positioning a substrate with an exposed surface in a processing chamber, injecting an electrically charged silicon-containing material towards the surface of the substrate, depositing silicon-containing nanofibers onto the exposed surface of the substrate, and depositing a thin low surface energy layer over the exposed surface of the substrate and the silicon-containing nanofibers.

In another embodiment, a method for creating a super-hydrophobic and super-oleophobic layer can include positioning a substrate with an exposed surface in a processing chamber, treating the exposed surface of the substrate with a thin transparent oxide film, applying a voltage to a nozzle to eject an electrically-charged silicon-containing material towards the exposed surface of the substrate, shaping an electric field adjacent to the substrate to control the trajectory of the electrically-charged silicon-containing material towards the exposed surface of the substrate, depositing the electrically-charged silicon-containing deposition material on the surface of the substrate in a predetermined pattern by controlling the trajectory, wherein nanofibers are formed by the deposition, and coating the substrate with a thin low surface energy layer.

In another embodiment, a method for creating a super-hydrophobic and super-oleophobic surface can include positioning a substrate with an exposed surface in a processing chamber, injecting a TEOS-containing deposition material towards the surface of the substrate, depositing one or more layers of silicon dioxide nanofibers onto the exposed surface of the substrate, wherein the thickness of the nanofiber layers is no greater than 150 nm, shaping an electric field adjacent to the substrate to control the trajectory of the electrically-charged silicon-containing material towards the exposed surface of the substrate, depositing the electrically-charged silicon-containing deposition material on the surface of the substrate in a predetermined pattern by controlling the trajectory, wherein nanofibers are formed by the deposition, and depositing a layer of PTFE (polytetrafluoroethylene) or PFDA (Poly(perfluorodecyl acrylate): H₂C═CHCO₂(CH₂)₂(CF₂)₇CF₃) over the exposed surface of the substrate and the silicon-containing nanofibers using an iCVD process.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an embodiment of a super-hydrophobic and super-oleophobic layer.

FIG. 2 depicts an embodiment of a super-hydrophobic and super-oleophobic layer using nanofibers.

FIG. 3 is a flow diagram applicable to one or more methods of depositing a super-hydrophobic and super-oleophobic layer.

FIG. 4 is a flow diagram applicable to one or more methods of depositing a super-hydrophobic and super-oleophobic layer with controlled nanofiber deposition.

FIG. 5 illustrates an electrospinning apparatus for depositing nanofibers according to one or more embodiments.

FIG. 6 depicts a process chamber according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the invention generally relate to methods of creating super-hydrophobic and super-oleophobic surfaces and the resulting composition of matter. One or more embodiments of the method for creating a super-hydrophobic and super-oleophobic surface can include creating a super-hydrophobic and super-oleophobic surface by depositing nanofibers on the surface of the substrate and depositing a low surface energy layer over the nanofibers.

In one or more embodiments, micro-texture is generated by electrospinning to form silicon dioxide or similar nanofibers with diameters in 100 nm scale. Then self-assembled monolayer with thickness ˜10 nm or less is deposited over the nanofibers by wet chemical immersion, or highly hydrophobic coating with thickness in nanometer level by initiated chemical vapor deposition, or a combination of both is formed on the textured substrate to create a surface with super-hydrophobic properties.

The embodiments enclosed herein are more fully described with reference to the figures below.

The limitations of prior art layers have required further search for higher contact angle layers with lower surface energy that can remain stable under harsh environments. A flat surface cannot achieve optimal hydrophobicity or oleophobicity, as a flat surface with a low surface energy layer can only achieve a contact angle of around 110 degrees. Super-hydrophobicity has been achieved to a limited extent using roughened surfaces. However, the process of roughening a surface can diminish transparency and decreases throughput of the substrate.

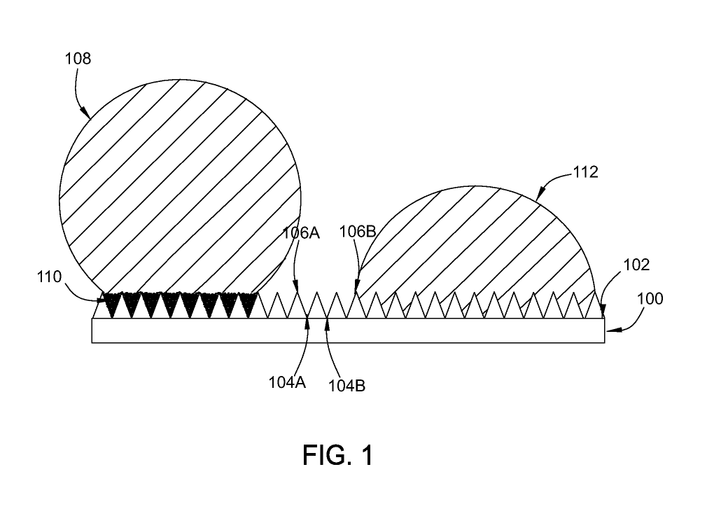

FIG. 1 depicts an embodiment of a super-hydrophobic and super-oleophobic layer. The substrate 100 can be a glass substrate with an upper surface 102. The upper surface 102 of the substrate 100 can be roughened treatment with either an abrasive chemical or other abrasive material to achieve the desired surface roughness. The roughened surface will have a plurality of roughness peaks 104a and 104b and accompanying roughness troughs 106a and 106b to create a so-called “Cassie-Baxter” wetting surface.

Wetting is defined as the ability of a liquid to maintain contact with a solid surface. Cassie-Baxter wetting is a theory of wetting involving two or more components composing a surface which creates a heterogeneous liquid interface, such as a micro-textured surface. On a roughened surface, the liquid may interface with both the trapped air and the solid peaks of the surface. To simplify for sake of brevity, the surface interactions of a roughened surface can be composed of the solid-liquid interface as a relatively small x and the air-liquid interface as a much higher 1-x, as depicted by the water droplet 108. Without intending to be bound by theory, it is believed that a roughened surface can be used to create Cassie-Baxter wetting by creating air bubbles 110 in the roughness troughs on a surface, such as the roughness troughs 106a and 106b. The surface still maintains its general surface energy state but the contact angle between the water and the solid surface is decreased due to the air bubble 110 under the water droplet, which decreases the solid-liquid interface. The surface becomes super-hydrophobic and super-oleophobic, as long as the air bubble remains in place.

Wenzel wetting describes a homogeneous wetted surface which occurs when the entire surface is wetted. In Wenzel wetting, as depicted with water droplet 112, the surface of the substrate is in greater contact with the water droplet 112 due to the increased surface area and no trapped air bubble in the roughness trough. Vibrations, heat or other movement can dislodge the air bubble leading to Wenzel wetting of the surface. As displayed on FIG. 1, in Wenzel wetting, the liquid would not only be in contact with the roughness peaks but also the roughness troughs creating a homogeneous solid liquid interface. This state of wetting is exacerbated on hydrophilic surfaces and is difficult to reverse. The movement from Cassie-Baxter wetting to Wenzel wetting is faster on higher surface energy surfaces.

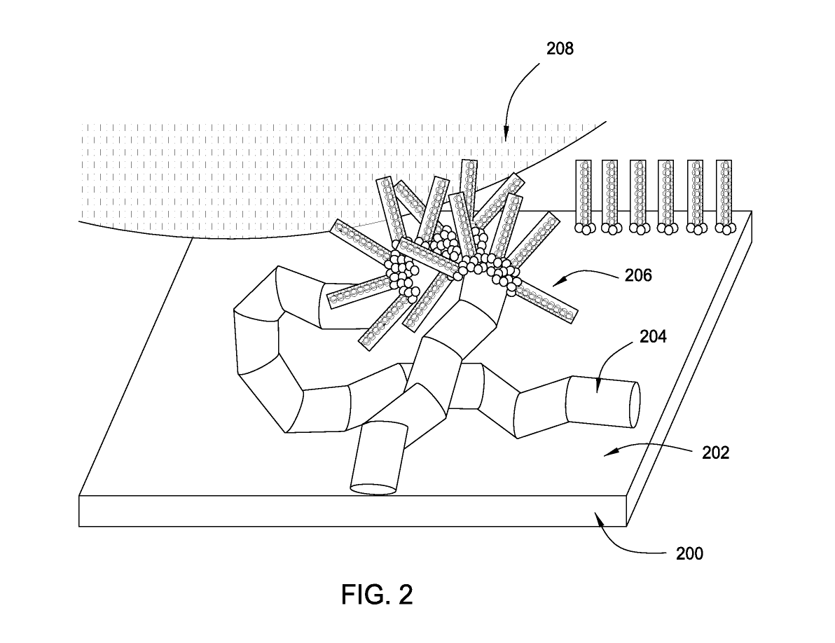

FIG. 2 depicts an embodiment of a super-hydrophobic and super-oleophobic surface using nanofibers. The substrate 200 used in the embodiments herein can be composed of any known material, as the embodiments of this invention are not limited to displays and touchscreens alone. In one or more preferable embodiments, the substrate 200 can be composed of a transparent material, such as glass.

The substrate 200 can have an upper surface 202. The upper surface 202 can be a substantially flat surface or it can be a roughened surface. In this example, the upper surface 202 is depicted as a substantially flat surface. The upper surface 202 can have a plurality of nanofibers 204 (not drawn to scale) disposed thereon. The nanofibers 204 can create a microtextured surface which will follow the contours of the either substantially flat or roughened upper surface 202. In one or more embodiments, the nanofibers 204 can be less than 150 nm thick as measured from the surface of the substrate, such as having nanofibers 204 less than 100 nm thick.

The nanofibers can have a uniform thickness or they can be of random thickness creating the desired surface roughness. Nanofibers 204 deposited with a uniform thickness can be helpful in maintaining the transparency of a transparent substrate. A combination of the nanofibers 204, troughs and peaks between and formed on the nanofibers 204, and the exposed upper surface 202 between the formed nanofibers 204 can create the roughness peaks and roughness troughs allowing for Cassie-Baxter wetting of the composite surface.

The nanofibers 204 can be composed of a transparent substance, such as silicon dioxide or a silicon-containing polymer. Transparency is unimportant for non-display purposes and, as such, non-display substrates may use non-transparent nanofibers without diverging from the embodiments described herein.

A thin conformal low surface energy layer 206 can be deposited over the surface of both the exposed upper surface 202 and the nanofibers 204. The combination of the low surface energy layer and the nanofibers can create a super-hydrophobic and super-oleophobic surface. Many types of surfaces can benefit from a super-hydrophobic and super-oleophobic surface. A super-hydrophobic and super-oleophobic surface can reduce cleanings for windows in buildings, reduce scratching of touchscreens, make solar panels self cleaning in the presence of moving water and even reduce wear on auto glass due to the environment. As such, there is great interest in the development of resilient and transparent hydrophobic and oleophobic layer for use on transparent substrate.

Without intending to be bound by theory, the surface energy of a layer is believed to be directly proportional to hydrophobicity and oleophobicity. Contact angle can be explained as the balance between the attractive forces of molecules within the liquid (cohesive force) and the attractive forces of the liquid molecules with the molecules that make up the solid surface (adhesive force). An equilibrium is established between these forces at the energetic minimum. Surface energy results from a combination of dispersive (van der Waals) and non-dispersive (polar and Lewis acid-base) interactions at the surface liquid interface. Thus, a high surface energy layer has a low contact angle denoting increased surface contact between a liquid and the layer. A low surface energy layer, such as a layer with a surface energy of less than 38 ergs/cm², e.g. a layer with a surface energy of less than 25 ergs/cm², has a high contact angle which is related to limited surface contact between the liquid and the layer. In one embodiment, TEFLON® (polytetrafluoroethylene) is the low energy layer as it has a surface energy of approximately 24 ergs/cm².

As depicted in FIG. 2, a droplet 208 may be supported on the nanofibers 204 coated with the thin low surface energy layer 206. The positioning of the nanofibers, the surface coating, the thickness of the nanofibers and the conformation of the nanofibers all play a role in maintaining the Cassie-Baxter wetting state.

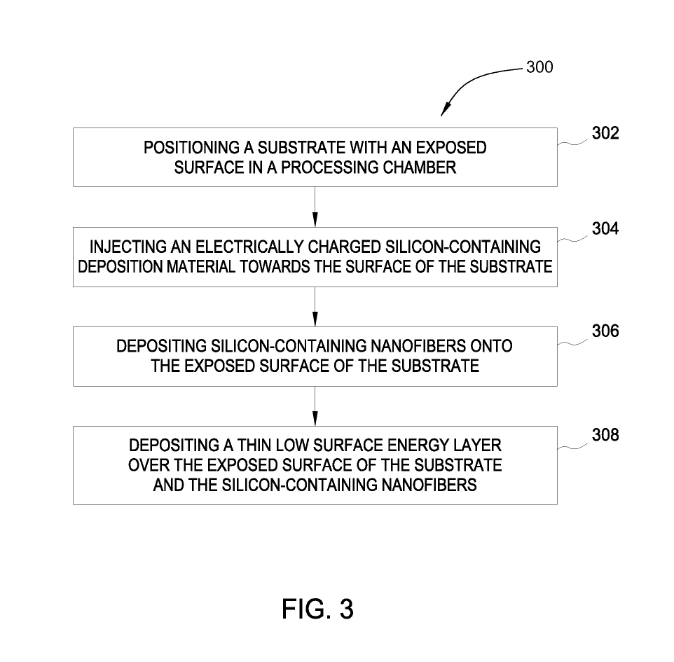

FIG. 3 is a flow diagram of the method of creating a super-hydrophobic and super-oleophobic surface according to one embodiment. The method 300 can include positioning a substrate with an exposed surface in a processing chamber, as in step 302. The substrate can be a variety of materials for surfaces where super-hydrophobic and super-oleophobic characteristics are beneficial, such as touchscreens for phones, the water contacting surface of boats, solar panels, windshields for car and others not explicitly disclosed here.

The method 300 further comprises injecting an electrically charged silicon containing material toward the surface of the substrate, also known as electrospinning, in step 304. Electrospinning can include applying a high voltage to a metallic capillary which can containing a deposition material, such as a deposition material including a polymer and a metal. The voltage applied to the capillary creates an electric field sufficient to overcome the surface tension of the deposition material, causing ejection of a thin jet of the deposition material onto a substrate. The deposition material is allowed to deposit on the substrate surface in a random orientation, which is generally dictated by the charged deposition material's affinity for the grounded substrate. An electric field, which dictates the trajectory of the charged deposition material, is generated between the metallic capillary and the substrate. Since the electric field is not focused at one point on the substrate, the deposition material deposits randomly over the entire surface of the substrate.

The electrospinning deposition material can deposit a silicon dioxide nanofiber, such as nanofibers deposited from a silicon deposition material composed of Tetraethyl Orthosilicate (TEOS):Ethanol:Water:Hydrogen Chloride at a 1:2:2:0.01 molar ratio providing a silicon content of 8.33 wt % in the solution. The needle can be positioned from 3 cm to 7 cm from the target plate, such as from 3 cm to 5 cm, and more preferred embodiments of 5 cm from the target plate. Ejection flow rate can be maintained between 350 μl/hr and 450 μl/hr, such as 400 μl/hr. The applied voltage forming the nanofibers can be from 6 kV to 8 kV, such as having an applied voltage of 6.7 kV. The deposition time can be between 12 s and 18 s, such as having a deposition time of 15 s.

The deposition process can be repeated to create the thickness of SiO₂ nanofibers that are desired. Once the desired thickness is achieved, the substrate can be heated to between 450° C. and 550° C., such as 500° C., to cure the nanofibers on the substrate surface. The heating process can be performed from 1.5 to 2.5 hours, such as of 2 hours. The heat and time frame can be to prevent damage to the substrate while simultaneously curing the SiO₂ nanofibers on the surface.

Further embodiments of the electrospinning deposition material can deposit a silicon-containing polymer, such as nanofibers deposited from a silicon deposition material composed of Polyvinyl Alcohol (PVA):Hexafluorosilicic Acid at a 1:15.7 weight ratio. The examples listed herein are not intended to be all encompassing and other embodiments of deposition material for electrospinning a silicon-containing nanofiber can be used in conformity with this invention.

The method 300 further comprises depositing silicon-containing nanofibers onto the exposed surface of the substrate, as in step 306. In one or more embodiments, the deposition of nanofibers can be performed as follows. A syringe with a plunger can be positioned over the substrate in an electrospinning chamber. The syringe can also include a metal needle which can be connected to an electrode. The plunger can be slowly depressed by a winding-drum mechanism to dispense the solution through the metal needle. The counter electrode can connected to the target substrate through the substrate support. The substrate, in one or more embodiments, can be placed 10-15 cm away from the tip of the metal needle. A voltage can be applied to the metal needle to overcome the surface tension of the deposition material, such as 10-20 kV. The voltage will generate a charged liquid jet, which can be deposited on the target substrate and form nanofibers, creating a textured substrate.

The method 300 further comprises depositing a thin low surface energy layer over the exposed surface of the textured substrate including the silicon-containing nanofibers, as in step 308. The thin low surface energy layer can be deposited by various techniques, such as iCVD, hotwire CVD or wet chemical immersion. Embodiments of the thin low surface energy layer include UV and heat resistant hydrophobic materials such as polytetrafluoroethylene (PTFE) and polyvinyl alcohol (PVA).

One embodiment of a wet chemical immersion process creating a self-aligned monolayer can be performed as follows. The textured substrate can be immersed in sulfuric acid/hydrogen peroxide solution (SPM) (Sulfuric Acid:Hydrogen Peroxide at a 4:1 ratio) which can hydroxylate the silicon containing nanofibers. The hydroxylated textured substrate can then be immersed in a concentrated ammonium hydroxide/hydrogen peroxide solution (SC1) (Ammonium Hydroxide:Hydrogen Peroxide at a 5:1 ratio). At this point, the hydroxylated textured substrate can be immersed into 10 mM OTS (Octadecyltrichlorosilane)/bicyclohexyl solution at room temperature for 2 hours. The OTS/bicyclohexyl solution can optimally be prepared in N₂-rich environment at room temperature (25° C.). The textured substrate can then be rinsed with Hexane. Subsequently the textured substrate can be rinsed in De-ionized Water at room temperature. Finally, the thin low surface energy layer can be dried at 70° C. The self-aligned monolayer can be less than 10 nm thick over the surface of the nanofibers and possible exposed surfaces of the substrate, such as no greater than 5 nm.

The thin low surface energy layer can also be deposited by initiated chemical vapor deposition (iCVD). In iCVD, a monomer and an initiator flow into a vacuum chamber where they contact resistively heated filaments. The initiator breaks down into radicals, beginning a free-radical polymerization of the monomer at the substrate surface. The substrate can be transferred to an iCVD processing chamber where the textured substrate would be positioned on a substrate support under a hotwire filament, such as a tungsten filament. The monomer can be previously disclosed UV and heat resistant hydrophobic materials, such as tetrafluoroethylene (TFE) and polyvinyl alcohol (PVA). The monomer species and the initiator species would be injected from separate chambers into the processing chamber, where the initiator species would be activated by the hot filament creating radicals to initiate polymerization of the monomer species and deposit a thin layer of the PTFE on the substrate. Further embodiments can employ the use of both a self aligned monolayer and iCVD deposition of a monomer, such as TFE.

One or more embodiments can also include depositing other low surface energy substances, such as PFDA (Poly(perfluorodecyl acrylate): H₂C═CHCO₂(CH₂)₂(CF₂)₇CF₃) film, to achieve a similar hydrophobic and oleophobic effect in accordance with the inherent properties of the deposited layer as enhanced by the surface roughness achieved with the nanofiber-coated surface. The hydrophobic and oleophobic layer can be deposited by known techniques in the art, such as polymer hot-wire chemical vapor deposition (PHCVD).

Experimental models have confirmed the super-hydrophobic nature of the hydrophobic coating over SiO₂ nanofibers. A layer of approximately 50 nm of PFDA was deposited over SiO₂ nanofibers. The PFDA layer was deposited using techniques known in the art for PHCVD deposition of standard polymers. Deionized H₂O was applied to the surface of the substrate post treatment. The water droplet formation was measured, showing a contact angle of approximately 158°.

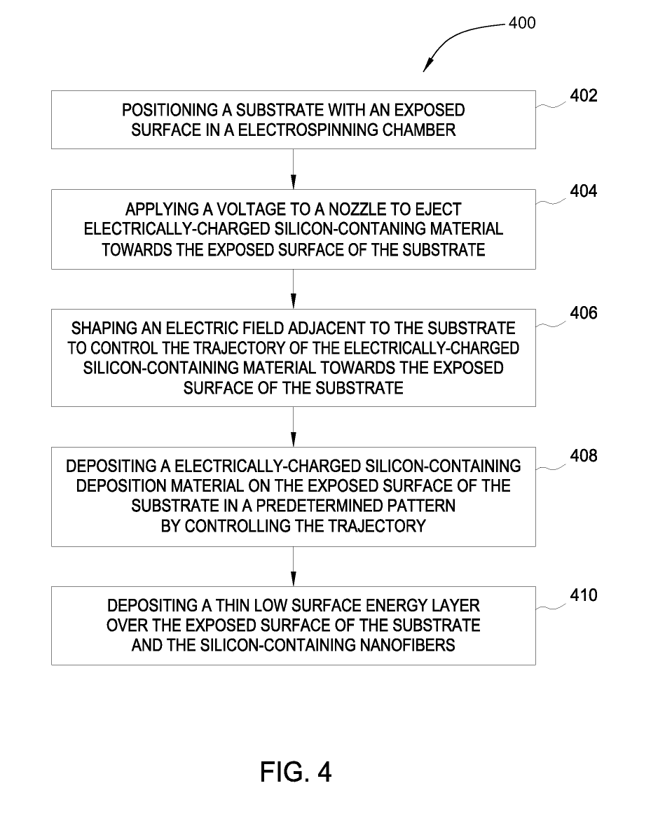

FIG. 4 is a flow diagram applicable to one or more methods of depositing a super-hydrophobic and super-oleophobic surface with controlled nanofiber deposition. The method 400 comprises positioning a substrate with an exposed surface in an electrospinning apparatus, as in step 402.

The method 400 further comprises applying a voltage to a nozzle to eject an electrically-charged silicon-containing material towards the exposed surface of the substrate, as in step 404. The application of a charge to the deposition material and the principles behind the deposition as silicon-containing nanofibers have been described in greater detail with reference to FIG. 3 above. The description above is incorporated by reference herein.

The method 400 further comprises shaping an electric field adjacent to the substrate to control the trajectory of the electrically-charged silicon-containing material towards the exposed surface of the substrate, as in step 406. Concurrent with the application of a voltage to the nozzle of the material delivery device, electric field lines adjacent to a substrate surface can be shaped, influenced, or formed in order to control the trajectory of the deposition material and to direct the deposition material onto the substrate in a predetermined pattern. The electric fields are shaped using one or more electric field shaping devices, such as coils or a counter electrode, which are electrically biased by the voltage source.

The method 400 further comprises depositing the electrically-charged silicon-containing deposition material on the surface of the substrate in a predetermined pattern by controlling the trajectory, wherein nanofibers are formed by the deposition, as in step 408. In operation, the one or more electric field shaping devices converge the electric field lines and direct the charged deposition material onto the substrate surface via electrostatics in order to form a predetermined one-, two-, or three-dimensional pattern on the substrate. The predetermined pattern may correspond to a desired structure, such as a glass sheet.

The nanofibers deposited on the substrate by this method can be controlled to produce equal length nanofibers and specific spacing of nanofibers. The length and spacing of the nanofibers is important to opacity of the deposition layer on screens or displays. As such, controlling these key facets of the nanofibers will allow for the production of super-hydrophobic and super-oleophobic layers that do not distort or create haze on the screen.

Without intending to be bound by theory, it is further believed that controlling the distance between the peaks can control the retention of air bubbles, thus allowing the surface to maintain the Cassie-Baxter wetting state over a greater period of time in the presence of liquid. Without random deposition of fibers, all roughness troughs can approach the same size thereby assuring more consistent results across the surface of the substrate.

The nanofibers may be deposited in one or more steps. The nanofibers can be deposited in 25 nm thickness per cycle intervals and, if such a deposition interval is used, a preferred embodiment can include from 3 to 4 deposition cycles. The nanofibers should be maintained at less than the critical thickness of 150 nm, such as 100 nm or less. It is believed that, at a thickness greater than 150 nm, the silicon-containing nanofibers will begin to deflect light making the screen visible.

The method 400 further comprises depositing a thin low surface energy layer over the exposed surface of the substrate and the silicon-containing nanofibers, as in step 410. The various techniques for coating the substrate with a thin low surface energy layer including embodiments have been described in detail with reference to FIG. 3 above. The description above is incorporated by reference herein.

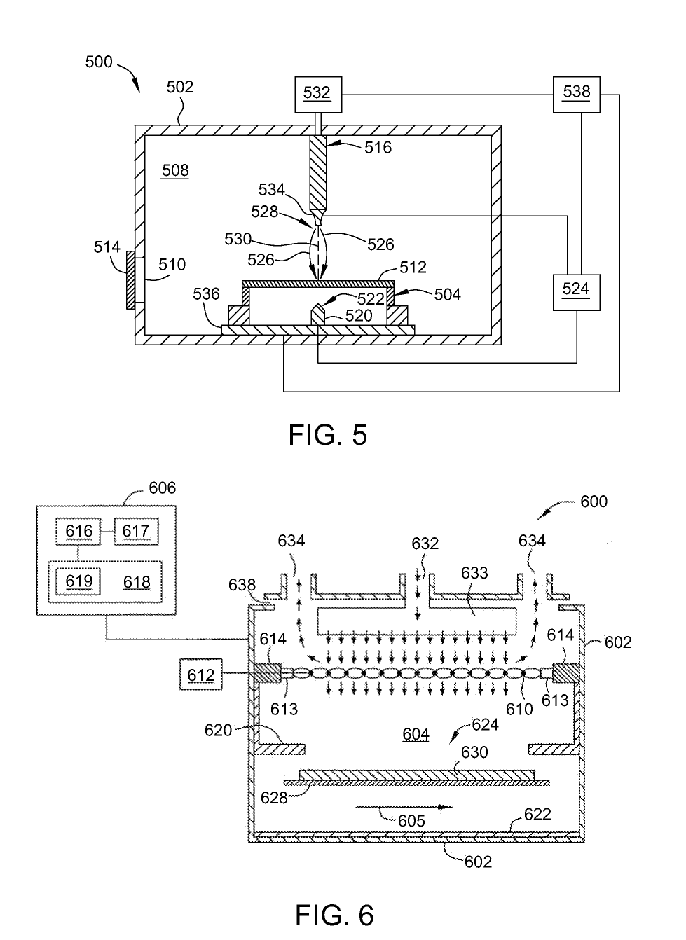

FIG. 5 illustrates an electrospinning apparatus 500 for depositing nanofibers according to one or more embodiments. The electrospinning apparatus 500 includes an enclosure 502 having a substrate support 504 and a material delivery device 516 disposed therein. The enclosure 502 is formed from poly(methyl methacrylate) and is used to environmentally isolate an interior 508 of the electrospinning apparatus 500. An opening 510 is formed through the enclosure 502 to facilitate ingress and egress of a substrate 512 to and from the interior 508 of the electrospinning apparatus 500. An actuatable door 514 is adapted to seal the opening 510 during an electrospinning process and to facilitate environmental isolation of the enclosure 502.

The substrate support 504 is positioned within the enclosure 502 in a lower portion of the interior 508 of the electrospinning apparatus 500. The substrate support 504 is adapted to support the substrate 512, such as a sheet of glass, polypropylene, or polyethylene terephthalate, adjacent to the material delivery device 516. The substrate support 504 is a frame having an opening formed through a central portion thereof to expose a back surface of the substrate 512 (e.g., the surface opposite the material delivery device 516) to a counter electrode 520. The opening through the substrate support 504 allows the counter electrode 520, such as an electrically conductive pin, post, or cylinder, to be positioned adjacent to the back surface of the substrate 512. The substrate support 504 is movable relative to the material delivery device 516 and the counter electrode 520 on a stage 536 positioned in the bottom of the enclosure 502. Movement of the stage 536 is facilitated by an actuator (not shown) and tracks formed within or on the bottom of the enclosure 502. Movement of the stage 536 along the bottom of the enclosure 502 facilitates the formation of a predetermined one- or two-dimensional pattern on an upper surface of the substrate 512 during processing. Thus, during an electrospinning process within the electrospinning apparatus 500, the counter electrode 520 and the fluid delivery device 516 remain stationary, while the substrate 512 is moved relative to the counter electrode 520 and the fluid delivery device 516 to form a pattern of deposition material on the substrate surface. In one example, the predetermined pattern may be a one-dimensional pattern such as a line, or may be a two-dimensional pattern such as a weave or perpendicular lines.

The counter electrode 520 functions as an electric field shaping device. The counter electrode 520 is formed from an electrically conductive material, for example, a metal such as aluminum. The counter electrode 520 is coupled to a voltage source 524 which applies an electric potential to the counter electrode 520. The electrically charged counter electrode 520 shapes or influences electric field lines 526 located within a process region 528 between the material delivery device 516 and the substrate support 504. The counter electrode 520 causes the electric field lines 526 to converge at a single point near the surface of the substrate 522. The counter electrode 520 includes a tip 522 having a conical shape positioned at an end of the counter electrode 520 closest to the substrate 512. The tip 522 enables more precise control over the divergence point of the electric field lines 526. The tip 522 has a base width of about 50 millimeters and a height of about 5 millimeters.

The material delivery device 516, such as a syringe, is positioned adjacent to an upper surface of the substrate 512 and is adapted to deliver a deposition material 530 from a reservoir 532 through a nozzle 534 of the material delivery device 516 to the upper surface of the substrate 512. The nozzle 534 is also formed from an electrically conductive material, for example, a metal such as stainless steel, and is coupled to the voltage source 524. The nozzle 534 is adapted to be electrically biased by the voltage source 524, which overcomes the surface tension of the deposition material 530 present in the nozzle 534, thus ejecting the deposition material 530 towards the substrate 512.

A controller 538 is connected to the reservoir 532, the voltage source 524, and the stage 536 for controlling processes within the electrospinning apparatus 500. The controller 538 controls the electric potential applied to the nozzle 534 and the counter electrode 520, as well as the movement of the stage 536, thus controlling the amount and position of deposited material on the upper surface of the substrate 512. The controller 538 facilitates formation of a predetermined pattern of deposition material 530 on the surface of the substrate 512 by controlling the x-y movement of the stage 536.

During an electrospinning deposition process in the electrospinning apparatus 500, a deposition material 530 from the reservoir 532 is provided to the material delivery device 516. The deposition material 530 is suspended in the nozzle 534 of the material delivery device 516 by capillary action until an electric potential from the voltage source 524 is applied to the nozzle 534. The electric potential from the voltage source 524 overcomes the surface tension of the deposition material 530 in the nozzle 534, causing the deposition material 530 to be ejected from the nozzle 534. The application of the electrical potential from the voltage source 524 electrically charges the deposition material 530 ejected from the nozzle 534. The nozzle 534, and correspondingly the deposition material 530, is generally biased with a first polarity while the counter electrode 520 is biased with the opposite polarity. Biasing of the counter electrode 520 with the opposite polarity results in the convergence of an electric field near the surface of the substrate 512, thus directing the charged deposition material 530 to a desired area of the substrate. The deposition material 530 is attracted to the substrate at a point immediately above the tip 522 of the counter electrode due to the convergence of the electric field lines 526 caused by the counter electrode 520, thereby facilitating accurate deposition of the deposition material 530 on the substrate 512. Since the deposition material 530 is directed to a point immediately above the counter electrode 520, the substrate support 504 can be moved relative to the counter electrode 520 to deposit the deposition material 530 in a predetermined one- or two-dimensional pattern. For example, while deposition material 530 is being ejected from the nozzle 534, the substrate support 504 can be moved in the x-y directions to deposit a weave, perpendicular lines, or other predetermined patterned on the surface of the substrate 512.

While FIG. 5 illustrates one embodiment of an electrospinning apparatus 500, other embodiments are also contemplated. In another embodiment, it is contemplated that the substrate support 504 may remain stationary within the enclosure 502 while either or both of the counter electrode 520 and the material delivery device 516 are movable. In yet another embodiment, it is contemplated that the substrate 512 may be a roll-to-roll or flexible substrate, and that the substrate support 504 may be adapted to support a flexible substrate using rollers. In yet another embodiment, it is contemplated that the dimensions of the tip 522 of the counter electrode 520 may be adjusted to effect the desired accuracy of alignment of the deposition material 530. Additionally, although the counter electrode 520 is described as shaping the electric field lines 526, it is to be understood that in some embodiments, the counter electrode may facilitate formation of the electric field lines 526, and not just shaping of the electric field lines 526.

In FIG. 6, a process chamber 600 which can be used for one or more of the CVD processes described above is provided. The process chamber 600 is a hot wire chemical vapor deposition (HWCVD) process chamber and generally comprises a chamber body 602 having a processing region. The processing region is within an internal processing volume 604 and is generally above a substrate support assembly 628 where a substrate 630 to be processed is disposed thereon.

pow One or more metal filaments 610, or wires, disposed within the chamber body 602 (e.g., within the internal processing volume 604), generally make up a HWCVD source. The plurality of filaments 610 may also be a single wire routed back and forth across the internal processing volume 604. The one or more metal filaments 610 comprise a HWCVD source. The metal filaments 610 may comprise any suitable conductive material, for example, tantalum (Ta), titanium (Ti), ruthenium (Ru), aluminum (Al), hafnium (Hf), molybdenum (Mo), tungsten (W), chromium (Cr), cobalt (Co), platinum (Pt), iridium, or the like. The filament material may be chosen to be the same metal material to be deposited on the surface of the substrate 630 such that contamination of the deposited thin film due to the evaporation of the filament is not a concern. Such a selection is in contrast to the hot wire process assisted CVD process used for silicon based materials where the evaporation of the filament material will take place and contaminate the film deposited on the surface of the substrate.

The metal filaments 610 may be in any thickness suitable to provide a desired temperature to facilitate a process in the process chamber 600. For example, in some embodiments, each metal filaments 610 may comprise a diameter of about 0.1 mm to about 3 mm, or in some embodiments, about 0.5 mm. The metal filaments 610 used in the process chamber 600 can be two to three meters long and can expand after being heated.

The metal filaments 610 may be coupled to a plurality of connectors 613 and support structures 614 disposed within the chamber body 602 to keep each metal filament (wire) taut when heated to high temperature, to provide electrical contact to the metal filaments 610, and to facilitate heating the metal filaments 610. The connectors 613 and the support structures 614 support the metal filaments 610 in a desired position and configuration within the process chamber 600, for example, such as along the walls of the chamber body 602, although other locations may also be used. Alternatively or in combination, some or all of the connectors 613 may be mounted directly in or on the chamber body 602, or on some other component of the process chamber which may act as the support structure 614. In addition, the support structures 614 may include one or more pieces and may be coupled together to form a singular structure or may be provided as a plurality of support structures on either side of the process chamber 600.

The connectors 613 and the support structure 614 can be used to tension the metal filaments 610 in the process chamber 600. The metal filaments 610 must be held at an appropriate tension (or within an appropriate tension range) at all times. The acceptable tension range may depend upon factors such as the composition of the metal filaments, the diameter of the metal filaments, the operating temperature of the metal filaments, and the like. Too much tension in the metal filaments may lead to breakage of the metal filaments, while too little tension in the metal filaments may result in filament sagging, which can result in the metal filaments touching another object (for example, causing an electrical short, or causing the wire to cool). Moreover, variation in the tension of the metal filaments may also lead to filament fatigue and wire breakage.

In some embodiments, a distance between each individual wire of the metal filaments 610 (e.g., a wire-to-wire distance) may be varied to assist in providing a desired temperature profile within the process chamber 600. For example, in some embodiments, the wire to wire distance may be in a range from about 45 mm to about 90 mm, while in some embodiments, the distance will more particularly be about 60 mm. A power supply 618 is coupled to the metal filaments 610 to provide an electrical current thereto and heat the metal filaments 610. The power supply 618 may be coupled to the metal filaments 610 via the connector 613.

For example, the substrate 630 on the substrate support assembly 628 is positioned under a HWCVD source (e.g., the metal filaments 610). The substrate support assembly 628 may be stationary for static deposition, or may move (as shown by an arrow 605) for dynamic deposition as the substrate 630 passes under the HWCVD source.

The chamber body 602 includes one or more gas inlets (e.g., a gas inlet 632 as shown) for supplying one or more source compounds, processing gases, carrier gases, purge gases, cleaning gases, and combinations thereof from one or more gas sources. A first gas source may contain a source compound for depositing a metal thin film over the surface of the substrate 630. The source compound may be a monomer for the deposition of an oleophobic or hydrophobic layer, such as PFDA or TFE described above.

In another embodiment, the gas inlet 632 may also be connected to a second gas source for supplying carrier gases and inert gases into the process chamber, together with the metal-containing source compound. a second gaseous material into the process chamber 600. Examples of carrier gases which may be used include, but are not limited to, helium (He), argon (Ar), nitrogen (N₂), and hydrogen (H₂). Other gaseous material, such as carbon-containing gases, hydrogen gas, nitrogen gas, ammonium, oxygen gas, cleaning gases, and combinations thereof, may be delivered into the process chamber 600 for cleaning or densifying a thin film deposited on the surface of the substrate within the process chamber 600, or for cleaning the process chamber 600.

The chamber body 602 may also include one or more outlets (two outlets 634 as shown) to a gas evacuation system (e.g., a vacuum pump, not shown) to maintain a suitable operating pressure within the process chamber 600 and to remove excess process gases and/or process byproducts. The gas inlet 632 may feed into a shower head assembly 633 (as shown), or other suitable gas distribution assembly, to distribute gases and source compounds uniformly, or as desired, over the metal filaments 610.

In addition, one or more shields 620 are placed between the metal filaments 610 and the substrate 630 and form an opening 624 that defines the processing region above the substrate 630. The shields 620 are provided to minimize unwanted deposition on interior surfaces of the chamber body 602. Alternatively or in combination, one or more chamber liners 622 can be used to make cleaning the process chamber 600 easier. Typically, the shields 620 and chamber liners 622 may be fabricated from aluminum (Al) and may have a roughened surface to enhance adhesion of deposited materials (to prevent flaking off of deposited material). The shields 620 and chamber liners 622 may be mounted in the desired areas of the process chamber 600, such as around the HWCVD sources, in any suitable manner.

The shields 620 and chamber liners 622 may be removable, replaceable, and/or cleanable. The shields 620 and chamber liners 622 may be configured to cover every area of the chamber body that could become coated, including but not limited to, around the metal filaments 610 and on all walls of the coating compartment. The use of shields, and liners, may preclude or reduce the use of undesirable gases (e.g., greenhouse gas NF₃) for cleaning the chamber body 602.

The shields 620 and chamber liners 622 generally protect the interior surfaces of the chamber body 602 from undesirably collecting deposited materials due to the process gases flowing in the chamber. In some embodiments, the source, shields, and liners may be removed for maintenance and cleaning by opening an upper portion of the process chamber 600. For example, in some embodiments, the lid, or ceiling, of the process chamber 600 may be coupled to the chamber body 602 along a flange 638 that supports the lid and provides a surface to secure the lid to the chamber body 602.

A controller 606 may be coupled to various components of the process chamber 600 to control the operation thereof. Although schematically shown coupled to the process chamber 600, the controller 606 may be operably connected to any component that may be controlled by the controller 606, such as the power supply 618, a gas supply (not shown) coupled to the gas inlet 632, a vacuum pump and or throttle valve (not shown) coupled to the outlet 634, the substrate support assembly 628, and the like, in order to control the HWCVD deposition process. The controller 606 may be one of any form of general-purpose computer processor that can be used in an industrial setting for controlling various chambers and sub-processors. The controller 606 may control the HWCVD process chamber 600 directly, or via other computers or controllers (not shown) associated with particular support system components.

The controller 606 generally comprises a central processing unit (CPU) 616, a memory 618, and support circuits 617 for the CPU 616. The memory 618 (e.g., a computer-readable medium) of the CPU 616 may be one or more of readily available memory such as random access memory (RAM), read only memory (ROM), floppy disk, hard disk, flash, or any other form of digital storage, local or remote. The support circuits 617 are coupled to the CPU 616 for supporting the processor in a conventional manner. These circuits include cache, power supplies, clock circuits, input/output circuitry and subsystems, and the like. Inventive methods as described herein may be stored in the memory 618 as software routine 619 that may be executed or invoked to turn the controller 606 into a specific purpose controller to control the operation of the process chamber 600 in the manner described herein. The software routine may also be stored and/or executed by a second CPU (not shown) that is remotely located from the hardware being controlled by the CPU 616.

The substrate 630 may be circular or rectangular in shape and have a surface for deposition of thin film thereon. The substrate 630 may be a silicon substrate, a glass substrate, a polymer substrate, a metal substrate, or other suitable substrate. Examples of the process chamber 600 include a single shower head CVD chamber system, a dual shower head CVD chamber system as well as the AKT® CVD systems available from Applied Materials, Inc., of Santa Clara, Calif.

### EXAMPLES

One proposed method for forming super-hydrophobic coating can consist of the following steps. In the first step, a proper chemical solution can be prepared to contain a sufficient quantity of the silicon component while maintaining bulk viscosity to allow nanofibers drawn with electrospinning process. In one embodiment, Tetraethyl Orthosilicate (TEOS):Ethanol:Water:Hydrogen Chloride are prepared at a 1:2:2:0.01 molar ratio, which provides a silicon content of 8.33 wt %. In another embodiment, Polyvinyl Alcohol (PVA):Hexafluorosilicic Acid can be prepared at a 1:15.7 weight ratio, Silicon content 6 wt %.

In the second step, the silicon-contained solution can be electrospun to form either silicon dioxide nanofibers or silicon-containing polymer nanofibers on a target substrate. In one embodiment, a syringe with a plunger can be slowly depressed by a winding-drum mechanism to dispense the solution through a metal needle, where the electrode is directly connected. The counter electrode can be connected to the target substrate. The counter electrode can be placed 10-15 cm away from the tip of the metal needle. 10-20 kV can applied to the tip of the needle during the electrospinning process to generate a charged liquid jet, which lands on the target substrate and forms nanofibers. A variety of materials can be used as target substrate for the electrospin process. In one embodiment, float glass or flexible plastic sheets can be used as the substrate for touch screen applications. Optional furnace treatment, such as a treatment of approximately 500° C. for 2 hours, can be used to burn polymers with silicon dioxide nanofibers remaining on the substrate, finalizing a surface micro-texture.

In the third step, a super-hydrophobic coating can be formed. In one embodiment, a self-aligned monolayer is grown by wet chemical immersion. The wet chemical immersion can include hydroxylating the silicon dioxide nanofibers with SPM (Sulfuric Acid:Hydrogen Peroxide=4:1) treatment followed by concentrated SC1 (Ammonium Hydroxide:Hydrogen Peroxide=5:1) immersion. After SC1 immersion, the hydroxylated textured substrate can be immersed into 10 mM OTS (Octadecyltrichlorosilane)/ bicyclohexyl solution at room temperature for 2 hours, wherein the OTS/bicyclohexyl solution is prepared in a N₂-rich environment at room temperature. The textured substrate can then be rinsed with hexane followed by de-ionized water at room temperature followed by drying the self-aligned monolayer on textured substrate at 70° C.

In another embodiment, a low-surface-energy polymer coating is formed on the silicon dioxide nanofibers by chemical vapor deposition, where the initiator breaks down to radicals by resistive contact of heated filaments and facilitates free-radical polymerization of the monomer co-flow on the substrate. An example is Fluorine-terminated polymer deposition to enhance surface resistance to UV light.

In another embodiment, combinations of the self-aligned monolayer and the low-surface-energy are employed for coating the silicon dioxide nanotube textured substrate.

### CONCLUSION

Methods and apparatus for aligning nanofibers deposited during an electrospinning process are disclosed herein. The methods and apparatus utilize one or more electric field shaping devices to converge an electric field within the apparatus to a desired point. The electric field shaping devices facilitate formation and alignment of a predetermined pattern of nanofibers on the surface of a substrate. Thus, a metallic layer of uniform thickness and conductivity can be formed on the surface of a substrate. Metallic layers of uniform thickness and conductivity facilitate the formation of more efficient devices.

The benefits of the above described methods and apparatus include texturing with electrospun nanofibers which can be performed on a wide variety of surfaces (rigid or flexible, transparent or opaque, etc.), thus broadening potential applications. Self-assembled monolayer formation enhances both micro-texturing and smudge repellency effects. Initiated chemical vapor deposition conformally coats 3-dimensional nano-structures with low-surface-energy functional polymers in nano-level thickness control, which facilitates super-hydrophobic properties.

While the foregoing is directed to embodiments of the present invention, other and further embodiments of the invention may be devised without departing from the basic scope thereof, and the scope thereof is determined by the claims that follow. An attached appendix provides further information regarding the embodiments.

We claim:

1. A method for creating a super-hydrophobic and super-oleophobic surface comprising:
positioning a substrate with an exposed surface in a processing chamber;
injecting an electrically charged silicon-containing deposition material towards the exposed surface of the substrate;
depositing silicon-containing nanofibers onto the exposed surface of the substrate; and
depositing a thin layer with a surface energy of less than 25 ergs/cm² over the exposed surface of the substrate and the silicon-containing nanofibers.

2. The method of claim 1, wherein depositing the thin layer comprises a CVD process.

3. The method of claim 2, wherein the CVD process is initiated chemical vapor deposition (iCVD), which comprises a monomer species and an initiator species.

4. The method of claim 3, wherein the monomer species is tetrafluoroethylene (TFE).

5. The method of claim 1, further comprising repeating the depositing silicon-containing nanofibers step until the nanofibers reach a desired thickness and pattern.

6. The method of claim 5, wherein the nanofiber thickness is less than 100 nm.

7. The method of claim 6, wherein the thickness of the nanofibers is substantially uniform.

8. A method for forming a super-hydrophobic and super-oleophobic surface comprising:
positioning a substrate with an exposed surface in an electrospinning chamber;
applying a voltage to a nozzle to eject an electrically-charged silicon-containing material towards the exposed surface of the substrate;
shaping an electric field adjacent to the substrate to control the trajectory of the electrically-charged silicon-containing material towards the exposed surface of the substrate;
depositing the electrically-charged silicon-containing deposition material on the exposed surface of the substrate in a predetermined pattern by controlling the trajectory, wherein nanofibers are formed by the deposition; and
depositing a thin layer with a surface energy of less than 25 ergs/cm² over the exposed surface of the substrate and the silicon-containing nanofibers.

9. The method of claim 8, wherein the electrically-charged silicon-containing material comprises Tetraethyl Orthosilicate (TEOS).

10. The method of claim 8, wherein depositing the thin layer comprises a CVD process.

11. The method of claim 10, wherein the CVD process is initiated chemical vapor deposition (iCVD), which comprises a monomer species and an initiator species.

12. The method of claim 11, wherein the monomer species is tetrafluoroethylene (TFE).

13. The method of claim 8, further comprising repeating the ejecting, shaping and depositing steps until the nanofibers reach a desired thickness and pattern.

14. The method of claim 13, wherein the nanofiber thickness is less than 100 nm.

15. The method of claim 14, wherein the thickness of the nanofibers is substantially uniform.

16. A substrate with a super-hydrophobic and super-oleophobic surface comprising:
a substrate with an exposed surface;
one or more layers of nanofibers disposed on the exposed surface; and
a thin layer with a surface energy of less than 25 ergs/cm² deposited over both the nanofibers and the exposed surface.

17. The substrate of claim 16, wherein the substrate comprises glass.

18. The substrate of claim 17, wherein the nanofiber layers are less than or equal to 100 nm thick.

19. The substrate of claim 18, wherein the nanofibers are substantially equal in thickness over the surface of the substrate.

20. The substrate of claim 16, wherein the thin low energy surface material is tetrafluoroethylene (TFE).

21. A method for creating a super-hydrophobic and super-oleophobic surface comprising:
positioning a substrate with an exposed surface in a processing chamber;
injecting a TEOS-containing deposition material towards the surface of the substrate;
depositing one or more layers of silicon dioxide nanofibers onto the exposed surface of the substrate, wherein the thickness of the nanofiber layers is no greater than 150 nm;
shaping an electric field adjacent to the substrate to control the trajectory of the electrically-charged silicon-containing material towards the exposed surface of the substrate;
depositing the electrically-charged silicon-containing deposition material on the surface of the substrate in a predetermined pattern by controlling the trajectory, wherein nanofibers are formed by the deposition; and
depositing a layer of PTFE or PFDA over the exposed surface of the substrate and the silicon-containing nanofibers using an iCVD process.
